(19) United States
(12) Patent Application Publication
(10) Pub. No.: US 2018/0129901 A1
(43) Pub. Date: May 10, 2018

(54) SYSTEM ON CHIP AND METHOD FOR DATA PROCESSING

(71) Applicant: SAMSUNG ELECTRONICS CO., LTD., Suwon-si (KR)

(72) Inventors: Seok-hwan JO, Suwon-si (KR); Do-hyung KIM, Hwaseong-si (KR)

(21) Appl. No.: 15/653,570

(22) Filed: Jul. 19, 2017

(30) Foreign Application Priority Data
Nov. 7, 2016 (KR) 10-2016-0147374

(51) Int. Cl. G06K 9/46; G06T 5/30; G06T 7/194; G06T 7/11

(52) U.S. Cl. CPC G06K 9/4652; G06K 9/4671; G06K 9/4676; G06T 5/30; G06T 2207/20076; G06T 7/11; G06T 2207/10024; G06T 2207/20024; G06T 7/194

(57) ABSTRACT

An electronic apparatus is disclosed. The electronic apparatus includes a plurality of digital signal processors and a prediction processor configured to predict a complexity of each of a plurality of operations to be processed in the plurality of digital signal processors and to distribute the plurality of operations to the plurality of digital signal processors based on the predicted complexities.

### CROSS-REFERENCE TO RELATED APPLICATION

This application is based on and claims priority under 35 U.S.C. § 119 to Korean Patent Application No. 10-2016-0147374, filed in the Korean Intellectual Property Office on Nov. 7, 2016, the disclosure of which is incorporated by reference herein in its entirety.

### BACKGROUND

### 1. Field

The present disclosure relates generally to a system-on-chip and a method for data processing thereof, for example, to a system-on-chip which can efficiently distribute and process an operation to be perform in a plurality of digital signal processor cores through complexity prediction and a method for data processing thereof.

### 2. Description of Related Art

In one system-on-chip (SoC), not only hardware but also a digital signal processor (DSP) are provided and play a plurality of roles. For example, a digital signal processor may perform such roles as supporting the roles that hardware cannot perform or reducing an area of a system-on-chip and maximizing and/or increasing a processing ability thereof through a digital signal processor solution rather than designing each hardware to process a plurality of codecs. Further, if a new application appears subsequently, the operation that existing hardware cannot process may be processed by a software solution (a flexible platform solution).

A digital signal processor is used in many ways and the number of operations that a digital signal processor needs to process increases, and also the amount of computation of such operations has increased. Accordingly, the method of processing an application using a plurality of digital signal processors rather than processing by one digital signal processor has increased. In other words, a multi-core digital signal processor environment has increased, and a method for efficiently using such a digital signal processor is required accordingly.

### SUMMARY

As aspect of example embodiments of the present disclosure relates to a system-on-chip which may efficiently distribute and process an operation to be operated in a plurality of digital signal processor cores through a complexity prediction and a method for data processing thereof.

According to an example embodiment, a system-on-chip may include a plurality of digital signal processors and a prediction processor configured to predict a complexity of each of a plurality of operations to be processed in the plurality of digital signal processors and to distribute the plurality of operations to the plurality of digital signal processors based on the predicted complexities.

The prediction processor may obtain a plurality of pieces of property information with respect to each of the plurality of operations, and predict the complexity of each of the plurality of operations using a classifier comprising circuitry configured to receive the plurality of pieces of obtained property information as input values and to output one of a plurality of complexity scopes as a complexity.

The classifier may further receive operation environment information of the system-on-chip as an input value.

The classifier may be a support vector machine (SVM) or a deep neural network (DNN) which learns complexities of the plurality of pieces of property information and environment information of operations.

The classifier may include an internal coefficient value which is updated by update information transmitted from an external apparatus.

The classifier may compute a calculation result value for prediction of the complexities of the operations, and the prediction processor may distribute the plurality of operations in the plurality of digital signal processors using the predicted complexities and the computed calculation result value.

The prediction processor may distribute the plurality of operations in the plurality of digital signal processors using a priority of each of the plurality of operations and the predicted complexities.

The prediction processor may preferentially distribute an operation which requires a real-time process among the plurality of operations, and distribute an operation which does not require a real-time process to a digital signal processor having sufficient resource or delay processing of the operation.

The prediction processor may sequentially distribute a plurality of operations to be processed in the plurality of digital signal processors by a FIFO (first-in, first-out) method, and sequentially predict complexities of the plurality of operations accumulated in the FIFO.

The prediction processor may distribute the plurality of operations to the plurality of digital signal processors based on the predicted complexities and a complexity that is processible by each of the plurality of digital signal processors.

The plurality of digital signal processors and the prediction processor may be configured in one IC.

A method for processing data using a plurality of digital signal processors is provided, the method may include predicting a complexity of each of a plurality of operations to be processed in the plurality of digital signal processors, distributing the plurality of operations to the plurality of digital signal processors based on the predicted complexities and processing the plurality of distributed operations in the plurality of digital signal processors.

The predicting may include obtaining a plurality of pieces of property information with respect to each of the plurality of operations, and predicting the complexity of each of the plurality of operations using a classifier comprising circuitry configured to receive the plurality of pieces of obtained property information as input values and to output one of a plurality of complexity scopes as a complexity.

The classifier may further receive operation environment information of the system-on-chip including the plurality of digital signal processors as an input value.

The classifier may be a support vector machine (SVM) or a deep neural network (DNN) which learns complexities of the plurality of pieces of property information and environment information of operations.

The classifier may include an internal coefficient value which is updated by update information transmitted from an external apparatus.

The classifier may compute a calculation result value for prediction of the complexities of the operations, and the distributing may include distributing the plurality of operations in the plurality of digital signal processors using the predicted complexities and the computed calculation result value.

The distributing may include distributing the plurality of operations in the plurality of digital signal processors using a priority of each of the plurality of operations and the predicted complexities.

The distributing may include preferentially distributing an operation which requires a real-time process among the plurality of operations, and distributing an operation which does not require a real-time process to a digital signal processor having sufficient resource or delaying processing of the operation.

The distributing may include distributing the plurality of operations to the plurality of digital signal processors based on the predicted complexities and a complexity that is processible by each of the plurality of digital signal processors.

### BRIEF DESCRIPTION OF THE DRAWINGS

The above and other aspects, features and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example configuration of a system-on-chip according to an example embodiment;

FIG. 2 is a diagram illustrating an example operation of a complexity prediction according to an example embodiment;

FIG. 3 is a diagram illustrating an example configuration of a complexity prediction device of FIG. 2;

FIG. 4 is a diagram illustrating an example of a factor usable in a complexity prediction device according to an example embodiment;

FIG. 5 is a diagram illustrating an example of a classifier usable by a complexity prediction device according to an example embodiment;

FIG. 6 is a diagram illustrating an example of a complexity of a plurality of operations according to an example embodiment;

FIG. 7 is a diagram illustrating an example operation distribution method according to a conventional method;

FIGS. 8, 9 and 10 are diagrams illustrating an example operation of a distribution method and an effect thereof according to an example embodiment;

FIG. 11 is a diagram illustrating an example of distributing operations in each situation according to an example embodiment;

FIG. 12 is a diagram illustrating an example simulation result of FIG. 11;

FIG. 13 is a block diagram illustrating an example configuration of an electronic apparatus including a system-on-chip according to an example embodiment;

FIG. 14 is a flowchart illustrating an example data processing method according to an example embodiment; and

FIG. 15 is a flowchart illustrating an example processing method according to another example embodiment.

### DETAILED DESCRIPTION

Hereinafter, various example embodiments of the present disclosure will be described in greater detail with reference to the accompanying drawings. The example embodiments described below may be modified to diverse different forms and implemented. The detailed description for the feature that is well-known to a person having ordinary skill in the art including the below example embodiments may be omitted when needed to clearly describe the example embodiments.

It will be understood that when an element is “connected” with another element, the element may be “directly connected,” and also, the element may be ‘connected with another element in between.’ In addition, it will be understood that, when a certain part “includes” a certain element, the certain part may not exclude another element but further include another element unless this term is defined otherwise.

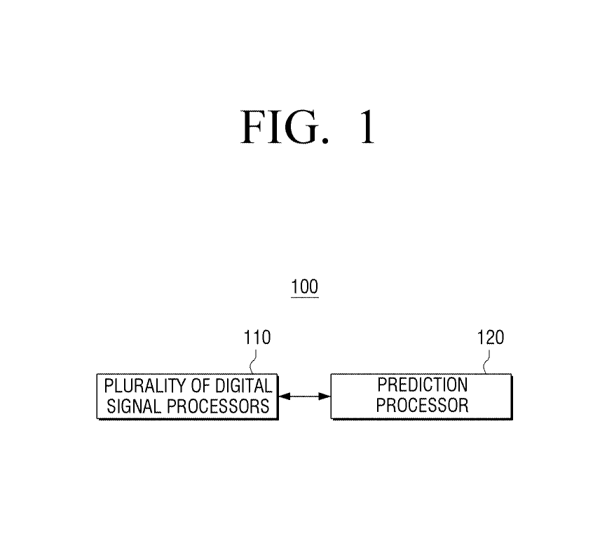

FIG. 1 is a block diagram illustrating an example configuration of a system-on-chip according to an example embodiment.

Referring to FIG. 1, the system-on-chip 100 may include a plurality of digital signal processors 110 and a prediction processor (e.g., including processing circuitry) 120. The system-on-chip 100 may be a processor, a control IC, a SoC or the like, but is not limited thereto.

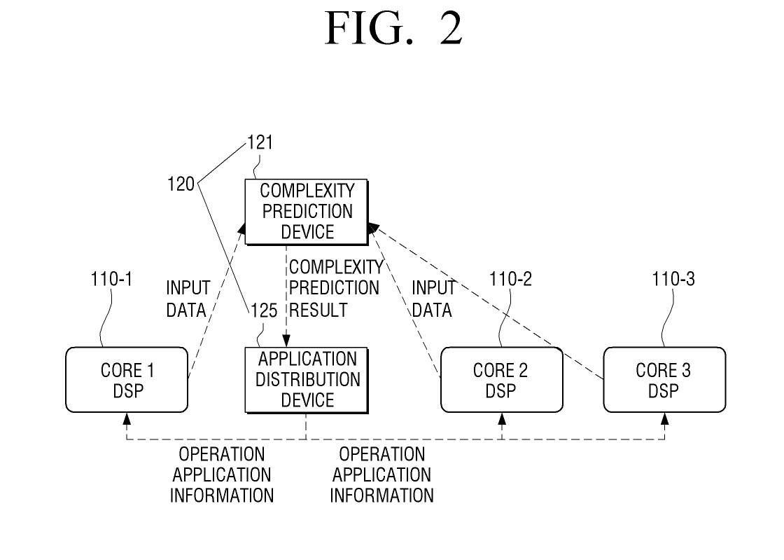

The plurality of digital signal processors 110 (DSP) may process distributed operations. For example, each of the digital signal processors 110 may process a certain application operation such as signal processing, decoding and encoding using a specialized calculator which can process repetitive computations such as addition, subtraction, multiplication, etc. at high speed to process a digital signal swiftly. The feature of the digital signal processors 110 will be described in greater detail below with reference to FIG. 2.

The plurality of digital signal processors 110 may obtain property information of an operation to be processed. For example, each of the digital signal processors 110 may obtain property information of an operation in advance before processing the operation, and provide the obtained property information to the prediction processor 120.

The prediction processor 120 may include various processing circuitry and distribute a plurality of operations to be processed in a plurality of digital signal processors to the plurality of digital signal processors 110. The prediction processor 120 may distribute the plurality of operations to be processed in a plurality of digital signal processors by an FIFO method, and sequentially predict the complexities of the plurality of operations accumulated in the FIFO. The prediction processor 120 may be configured as an exclusive processor which exclusively performs a distribution operation, or a CPU may perform such an operation.

To perform the above distribution, the prediction processor 120 may predict a complexity of each of the operations to be processed in a plurality of digital signal processors. For example, the prediction processor 120 may obtain a plurality of pieces of property information of each of the plurality of operations, and predict the complexity of each of the plurality of operations using a classifier (e.g., including circuitry and/or program elements) configured to receive the plurality of obtained property information as input values and to output one of a plurality of complexity scopes as a complexity. The classifier may use not only the plurality of pieces of obtained property information but also operation environment information of the system-on-chip as input values.

The property information of an operation may be a characteristic of computation and a parameter such as whether a Temporal Noise Shaping (TNS) is used, a Temporal Noise Shaping (TNS) filter degree, whether an Spectral extension (SPX) is used, an Fast Fourier Transform (FFT) point, etc., which affect a complexity of an operation. The environment information may be an operation state in the system-on-chip which can affect the performance of a digital signal processor such as whether certain hardware is operated, whether there is system heat, a delayed time in Dynamic Random Access Memory (DRAM) access, etc.

The classifier may be a support vector machine (SVM) or a deep neural network (DNN) which learns complexities of a plurality of pieces of property information and environment information of an operation. The learning may be conducted online or offline, or may be conducted by a manufacturing company, not by a system-on-chip, and update an internal coefficient value of the classifier through firmware update.

The prediction processor 120 may distribute the plurality of operations to the plurality of digital signal processors according to the predicted complexities. That is, the prediction processor 120 may distribute the plurality of operations to the plurality of digital signal processors based on the predicted complexities and a complexity that each of the plurality of digital signal processors can process.

The prediction processor 120 may distribute the plurality of operations considering a priority of each of the plurality of operations. For example, the prediction processor 120 may preferentially distribute an operation which requires a real-time process among the plurality of operations, and distribute an operation which does not require a real-time process to a digital signal processor having sufficient resource or delay processing of the operation.

The prediction processor 120 may also distribute the plurality of operations by additionally using a calculation result value that is computed in the process of predicting the complexities of the operations. The corresponding operation will be described below with reference to FIG. 2.

As described above, when the system-on-chip according to an example embodiment distributes a plurality of operations to a plurality of digital signal processors, the system-on-chip may predict a complexity of each operation in advance, thereby distributing the operations efficiently. Accordingly, the system-on-chip 110 of the present disclosure may improve efficiency in using a plurality of digital signal processors.

Meanwhile, in describing FIG. 1, it is described that the prediction processor 120 performs both the prediction of the complexity of each operation and distribution of the operations, but a plurality of processors may perform the operations after distinguishing the operations. The corresponding operation will be described in greater detail below with reference to FIG. 2.

Meanwhile, only the configuration of the system-on-chip has been described briefly, but various components may be additionally provided in the system-on-chip.

FIG. 2 is a diagram illustrating an example operation of a complexity prediction according to an example embodiment.

Referring to FIG. 2, in one system-on-chip, a plurality of digital signal processors 110-1, 110-2 and 110-3, a complexity prediction device (e.g., including processing circuitry and/or program elements) 121 and an application distribution device (e.g., including processing circuitry and/or program elements) 125 may be provided. The system-on-chip herein may be a technique and a product in which several semiconductor components are integrated as one.

If a plurality of digital signal processor cores are used in one system-on-chip, it might seem that many operations can be processed easily. However, a plurality of matters should be considered.

One matter that should be considered is a computing ability of each DSP core. If a computing ability of all the cores is set high, any operations could be processed, but considering power consumption and an area of system-on-chip, it is not easy to increase a computing ability of each core.

For example, if it is said that a maximum operating frequency of a digital signal processor core is set higher than 1 GHz to maximize a computing ability, the digital signal processor core may occupy a far wider area than the digital signal processor core operating in a lower operation frequency, and accordingly, the price of the system-on-chip may increase.

Further, if an operation frequency increases, power consumption may also increase exponentially, and hence, not only the power consumption may be a problem, but also the heat generated by the power consumption may cause a problem in entire operation of the system-on-chip.

Considering the above, a computing ability of one core in a multi-core digital signal processor environment is usually determined by analyzing usability, etc. when designing a system-on-chip.

In the situation where a computing ability of one digital signal processor core is determined in advance as above, the important matter that should be considered when operating a plurality of operations is ‘which operation is assigned and operated in which core.’

If a certain digital signal processor core should process the amount of computation that the core cannot handle as operations are not distributed properly, it may cause a problem in the entire operation of the digital signal processor. Therefore, in using a multi-core digital signal processor, it is important to consider which operation should be assigned in each core among the plurality of operations and by what method or logic the operation should be assigned in each core to operate the cores smoothly and to increase the efficiency in using the cores.

Meanwhile, the operation performed in a digital signal processor is different from the operation performed in a general processor such as a CPU. The reason is that a signal processing algorithm has small resource in comparison to that of a general processor, and that the digital signal processor was devised to process through a calculator specialized in signal processing at high speed.

For example, most of operations performed in a digital signal processor have a specialized purpose such as signal processing, a codec, etc., and such operations are different from a general operation in which it is difficult to predict what sort of operations would be performed, such as a CPU operation.

Further, a complexity of an operation performed in a digital signal processor is also different in that the level of complexity becomes different according to an operation, and the property of an aspect changing over time is also different.

For example, a required complexity of a video codec is usually greater than that of an audio codec, and that is because a video code has larger amount of data than an audio codec, and uses a complex algorism to increase compression efficiency.

As described above, a complexity value varies from a low complexity to a high complexity, and changes over time, which may be caused by the difference in characteristic of computation of an operation or by a variable from the outside of a system having a digital signal processor.

For example, if it is assumed that a multimedia code is recovered (decoding), a complexity may appear differently in each frame due to the type of coding tool used in each frame and a parameter used in each tool, etc.

Further, a delayed time in Dynamic Random Access Memory (DRAM) access may become different depending on whether hardware is operated, whether there is system heat, etc. besides an operation of a digital signal processor, and consequently, when a digital signal processor performs an operation, the complexity may become different.

However, as an operation of a digital signal processor is operated with a specialized purpose as mentioned above, it may be possible to infer a complexity changing over time, which is a significant difference from operation of a general processor.

For example, referring to bit stream information of a codec, what type of coding tool and parameter were used may be identified, and the type of filter used in image processing and the length of a filter, etc. may be identified while an operation is operated. Hence, a factor which determines a current complexity may be identified, and a current level of complexity may be inferred.

When using a conventional multi-core digital signal processor, the operation distribution method is simple. The operations to be performed by a digital signal processor are gathered, and the operations are assigned considering a computing ability of a core with reference to a complexity value when each operation reaches the highest level of complexity through a plurality of example computations. Hereinafter, the example situation in which the operations A, B, C and D are distributed to two digital signal processor cores having an operation frequency 500 MHz will be described.

First, a plurality of example computations may be performed by a digital signal processor core in each operation, and a peak complexity may be measured. If each peak complexity of A, B, C and D are 300 MHz, 400 MHz, 150 MHz, and 50 MHz, respectively, A and C may be assigned to core 1 and operated, and B and D may be assigned to core 2 and operated not to exceed 500 MHz that is an operation frequency of the cores.

Besides a multi-core digital signal processor, various methods for assigning an operation to each processor are present in the case of using a plurality of CPUs such as a server computer used in a data center. That is, in the prior art, usable resource of each processor is searched, and an operation is distributed by simply assigning an operation to a processor having sufficient resource.

However, such a conventional method does not distribute an operation based on analysis and reflection of a property of an operation. In other words, in the conventional method for distributing an operation, an operation is assigned to a multi-core with reference to a high complexity value of each operation which is obtained through a plurality of example operations, and the method has a huge risk in that an operation with even higher complexity may appear later.

In the case of an audio codec, for example, the AC-4 decoder of Dolby that is adopted as a current ATSC 3.0 audio codec does not use all the tools of the decoder for the reason that there are not many broadcast contents yet. That is, the operation complexity of the AC-4 decoder in a current broadcast scenario is far lower than that of decoding using all the tools of the AC-4 decoder. However, if a user's request for more extended sound field increases and broadcast contents also increase accordingly, the functions of the AC-4 decoder which have a high complexity would be used.

In this case, the conventional method for distributing an operation to a multi-core may be meaningless because the amount of computation could be exceeded, and the aforementioned process may be repeated to newly distribute an operation to a core. Or, another operation needs to be renounced if the complexity increases excessively than in the example of determining a complexity.

Further, another problem of the conventional method for distributing an operation is that it is often difficult to use a multi-core digital signal processor efficiently. Referring back to the above example, the method for assigning the operations A, B, C and D to two cores according to the highest complexity value of the operations may seem appropriate, but it may not be an efficient method.

Although the highest complexity value appears as above, if operations are performed with a lower value than the highest complexity value, mostly, an efficient operation distribution method may become different. For example, unlike a highest complexity, if an average complexity are 200 MHz, 350 MHz, 50 MHz and 45 MHz, it is more efficient to assign A, C and D to core 1 and only B to core 2 in usual circumstance in terms of complexity balance, and if the complexity balance improves, there may be an opportunity to add and operate a new operation.

Of course, if a highest complexity appears, there occurs a problem in operation because the complexity goes beyond the computing ability of a core, but if the assigning method can be changed in accordance with a complexity, it is possible to use a core efficiently in a multi-core digital signal processor environment.

Accordingly, the present disclosure relates generally to a device which predicts a complexity of an operation to distribute an operation in a multi-core digital signal processor efficiently.

The present disclosure is provided to maximize and/or improve the efficiency in using a multi-core by predicting a complexity of a current operation in real time through a complexity prediction device manufactured based on a classifier configured to learn a complexity using a machine learning technique, and to efficiently distribute a processing of an operation based on a current complexity to a multi-core. Further, the present disclosure suggests a situation adaptable operation distribution method to increase efficiency in using a multi-core and to prevent any problem in operating a system including a multi-core digital signal processor.

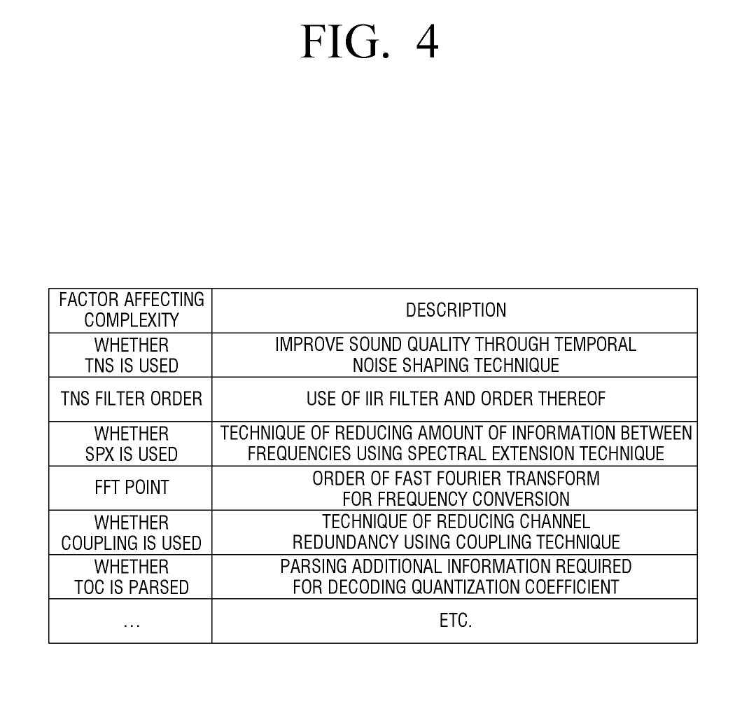

The present disclosure is different from that of an operation distribution (job portioning) of a general processor. For example, a general multi-processor uses a method of assigning an operation to a processor having sufficient resource with monitoring, but the present disclosure is different in that a complexity of an operation of a current core may be predicted in advance and a next operation to which the rest of resource is used is searched. Usually, in the case of most of operations performed in a general processor, it is difficult and sometimes impossible to predict a complexity of the operations. However, in the present disclosure, in the case of operation of a digital signal processor, a complexity can be inferred, and using the inferred complexity, a complexity may be predicted using a classifier configured to learn a complexity by a machine learning technique as illustrated in greater detail below with reference to FIG. 4.

Another difference is a distribution method. It may be possible to distribute an operation in a digital signal processor as distributed in a general processor, but it may not be easy to do so. That is, in the case of distributing an operation in a general processor, a thread may be generated, and accordingly, a current operation often needs to be stopped and a new operation is performed. However, in the case of operation of a digital signal processor, it is difficult to stop a current operation because the operation has a specialized purpose, and a current operation should be finished to operate a next operation. Or, a next operation often needs to use the result of a current operation.

Also, if a digital signal processor intents to use a thread function, the processor should have an 0/S function as a general processor does. However, most of digital signal processors do not support such a function because resource should be inserted into a small digital signal processor.

Therefore, in the case of distributing an operation in a multi-core digital signal processor environment, an operation being performed in a current core needs to be completed to operate a next operation. Thus, the method of selecting a next operation after predicting a complexity of a current operation may be an appropriate operation distribution method in a multi-core digital signal processor environment than the operation distribution method of a general processor.

Therefore, the prediction processor 120 according to an example embodiment includes a device (e.g., including processing circuitry and/or program elements) 121 configured to predict a complexity of an operation to be operated in a current core and a distribution device (e.g., including processing circuitry and/or program elements) 125 configured to efficiently distribute an operation to a core in accordance with a situation based on the predicted complexity.

The complexity prediction device 121 is configured based on a classifier which learns a complexity using a machine learning technique, and the factors affecting a complexity of an operation may be received from a plurality of digital signal processor cores 110-1, 110-2 and 110-3, and a complexity of the operation to be performed may be predicted in advance.

As illustrated above, as the level of complexity and the type of property of a complexity vary depending on an operation, the complexity prediction method should be based on the property of a current operation to distribute an operation to the plurality of digital signal processors 110-1, 110-2 and 110-3 efficiently.

For such complexity prediction, in an example embodiment, a complexity is predicted based on a classifier learning a complexity using a machine learning technique. A complexity of an operation is determined based on an internal factor caused by a characteristic of computation of an operation and a parameter and an external factor caused by an external environment. FIG. 4 illustrates an example of an internal factor determining a complexity of an audio decoder.

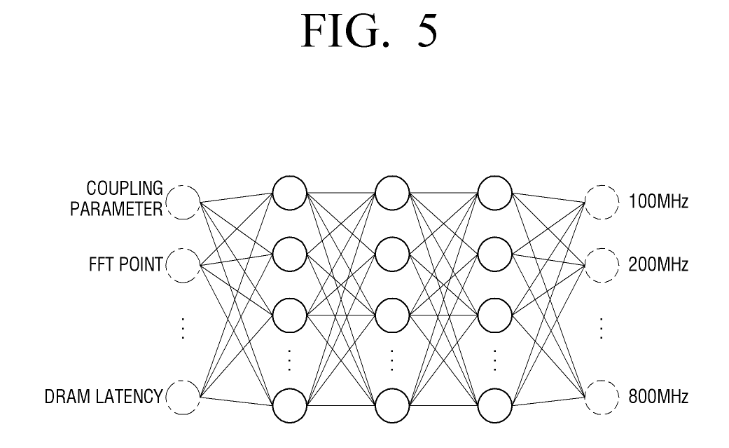

A representative example of an external factor may be, for example, a delayed time in Dynamic Random Access Memory (DRAM) access which varies in each time depending on whether hardware is operated, whether there is system heat, etc. besides operation of a digital signal processor. The factors may be received as one input data and applied to a classifier learning a complexity using a machine learning technique for complexity prediction, thereby predicting the level of complexity of a current operation. The example of the classifier may be a support vector machine (SVM) or a deep neural network (DNN) illustrated in FIG. 5 or the like.

In order to training the coefficients of a classifier to be used in the complexity prediction device, a plurality of input data sets and output data classes. In the case of training a classifier predicting a complexity of an audio decoder, the input data set may be the various parameter sets which determine the complexity of an audio decoder, which is illustrated in FIG. 4.

The output data class may be configured to be required from an operation distribution device which distributes an operation using the result of the complexity prediction device. If the operation distribution device selects a next operation only using the information that a complexity is high or low, the output data class may be ‘complexity high or low.’ If the operation distribution device distributes an operation using more detailed information than the above, a prediction range such as ‘complexity lower than 100 MHz, complexity of 100-200 MHz or 200-300 MHz,’ etc. may be determined as the output data class.

The input data set and the output data class may be put together by determining the output data class based on a parameter affecting a complexity and the corresponding complexity value with operating an audio decoder, and be used as data required in training a classifier.

The input data does not only consider the information obtained from decoding but also use a normalized version value, etc. which considers the maximum and minimum scopes that the above obtained values can have, and it can be identified which input data is more helpful to an actual complexity prediction after training. Such use of a normalized version value may not only prevent the training solely relying on a certain input parameter, but also decrease the number of pieces of input data required finally, which may be helpful to decrease the amount of calculation of a complexity prediction classifier.

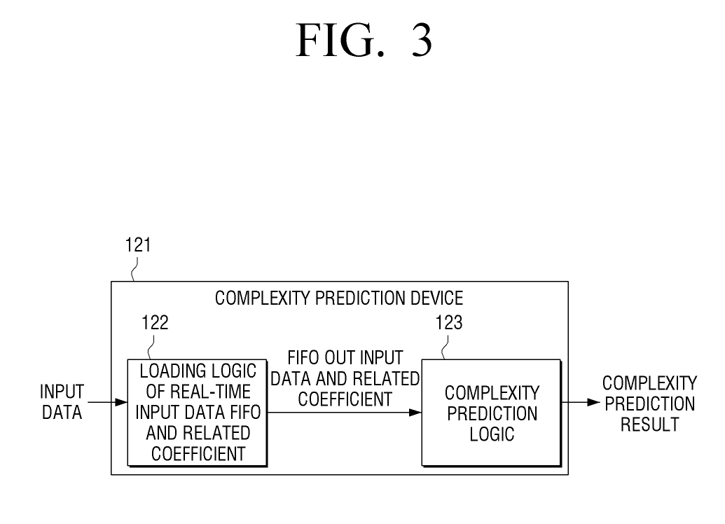

As illustrated in FIG. 3, the complexity prediction device 121 may operate in preparation for the case where input data is not simultaneously input but input sequentially by additionally applying a logic which receives input data. It will be described later referring to FIG. 3.

Meanwhile, the application distribution device 125 may distribute an operation considering not only a prediction result but also a complexity prediction reliability using a classifier calculation (determination) result value that is calculated (determined) to lead the prediction result when distributing an operation. For example, likelihood, posterior probability, score, distance, etc. may be usually used as a classifier calculation result, and a classification result is calculated by a certain threshold value or a predetermined criterion based on the above classifier calculation result values.

However, if a score value is calculated much higher than a threshold value for example, it is highly likely that the corresponding classification result is correct, and it may indicate that the reliability of the complexity prediction result is high. Therefore, the application distribution device 125 may distribute an operation referring to not only a prediction result of the complexity prediction device but also the reliability of the result.

Meanwhile, the application distribution device 125 may need to efficiently distribute a next operation of a core based on complexity information output through the complexity prediction device, and therefore, in the example embodiment, a situation adaptable operation distribution device which distributes an operation in accordance with a situation may be suggested. The situation herein may include not only a complexity situation but also a user scenario or an operation scenario. For example, an importance for a plurality of operations to be processed in a multi-core digital signal processor environment may be determined. When determining the importance, a user scenario or an operation scenario may be reflected. For example, if it is assumed that the importance of audio post-processing is determined, when a user views a movie through an existing TV, a voice clarification process, a sound amplification post-process, etc. may be preferentially processed by increasing the importance thereof. When a user views a VR content through a TV, an audio post-process of visual and auditory direction movement towards VR may be preferentially processed by increasing the importance thereof.

Therefore, the application distribution device 125 may analyze a current situation based on a predicted complexity, select a next operation to be operated in a core, and transfer the operation to the core so that the core can process the next operation after finishing a current operation.

As such, an operation may be distributed in accordance with a situation according to a complexity predicted in a current core based on an importance determined in accordance with an operation scenario. For example, if the types of the operations to be operated in a multi-core digital signal processor are a decoder, an encoder and various post-processing techniques, the importance of the decoder and the encoder may be preferentially determined so that the decoder and the encoder can be processed in real time because, if the decoder and the encoder are not operated in real time, the quality of product may be affected. The post-processing techniques may be determined such that the importance and the priority thereof can be changed in accordance with a situation as described above.

The decoder and the encoder may be operated in each core, and if the complexity of the decoder is predicted as high and the encoder is predicted as low, the plurality of post-processes may be operated in the core operating the encoder according to each priority, and the post-processes having a low complexity or a low priority may be distributed in the core operating the decoder.

If the complexity of the decoder and the encoder are both low, operations may be distributed such that all the post-processes can be operated to provide benefits to a user. If it is determined that the amount of calculation of a core could be exceeded as both the complexity of the decoder and the encoder are predicted as high, the application distribution device 125 may select and process an operation according to the priority of importance considering a situation, and distribute an operation without exceeding the amount of computation of a core ultimately.

In such an example above, the operation with a low priority may not be processed, but in the case where the operation for each module of an encoder should be assigned to a multi-core and processed, all the operations should be controlled not to exceed the amount of computation of a core. Hence, in such a case, the application distribution device 125 may more focus on a complexity distribution than on an importance and distribute an operation to each signal processing processor in order to prevent any problem in operation.

Further, the application distribution device 125 may use in operation distribution a complexity prediction result and a reliability thereof which are computed from the complexity prediction device. That is, if the prediction reliability is high, the complexity prediction result may be correct, and thus, the application distribution device 125 may be operated as described above. However, if the prediction reliability is low, the application distribution device 125 may be operated differently.

For example, in the case where the actual complexity is not low although the complexity prediction result is low, the amount of computation could be exceeded and it may cause a problem in overall operation. Therefore, if the prediction reliability is low, the application distribution device 125 may preferentially process an operation with a higher importance as a next operation regardless of a complexity prediction result to prevent any possible problem.

As described above, the system-on-chip 100 according to an example embodiment may directly receive data from an operation currently operated in a multi-core digital signal processor, predict a complexity, and distribute an operation efficiently reflecting the prediction. Accordingly, the system-on-chip 100 may improve efficiency in using a multi-core, and prevent a problem in operating a system including a multi-core digital signal processor.

The system-on-chip 100 according to an example embodiment may be differentiated from the prior art in that the system-on-chip 100 may directly use the information of a current operation on the basis of the technique based on a classifier which learns a complexity prediction by a machine learning technique. Further, according to the purpose of complexity prediction, the system-on-chip 100 according to an example embodiment may improve the level of completion by adding a logic so as to prevent and/or reduce a delay in the time when a prediction result comes out even if input data is sequentially received.

FIG. 3 is a diagram illustrating an example configuration of a complexity prediction device according to an example embodiment.

Referring to FIG. 3, the complexity prediction device (e.g., including processing circuitry and/or program elements) 121 may include a logic 122 which receives real-time input data and complexity prediction logic 123.

When using a classifier which learns by a general machine learning technique, an output value may be obtained by applying a classifier calculation while input data is given.

However, in the complexity prediction device according to an example embodiment, all pieces of input data may not be input simultaneously when the pieces of data are given, but be input at different time sequentially.

For example, in the case of a decoder, the parameters required for complexity prediction may be obtained according to an order of decoding while decoding a given bit-stream, and hence, the input data of the complexity prediction device is configured differently over times. If a calculation waits until the input data is configured in order to simultaneously apply all the input data to a classifier of the complexity prediction device, it may be impossible to know when the input is configured and when the complexity prediction result comes out. In other words, if the time when the complexity prediction result comes out is similar to, or later than, the time when processing of a current operation is finished, it may be useless to perform the selection of a next operation of a core through complexity prediction.

Therefore, as illustrated in FIG. 3, the complexity prediction device 121 may include a real-time input data FIFO and a related coefficient loading logic 122 in preparation for the case where the pieces of input data are not input simultaneously but input sequentially.

For example, the complexity prediction device 121 may accumulate the pieces of input data in an FIFO assigned in each core when the pieces of input data is received from a multi-core, and the classifier may load the value output from the FIFO and the coefficients required for the value, calculate using only those values and coefficients and store the values and coefficients. Therefore, the classifier calculation of the input data may be performed in advance through such a logic even when the pieces of input data are sequentially applied, and finally, the time when the complexity prediction result comes out may be advanced to prevent any problem in selecting and starting a next operation of a core through the operation distribution device.

Hereinafter, the difference between the distribution method used in the prior art and the distribution method according to an example embodiment will be described in detail through a plurality of examples of operations.

It is assumed that the multi-core digital signal processor environment uses two digital signal processors whose maximum operation frequency is 500 MHz, and that the applications to be operated in each digital signal processor core are a decoder, encoder and a post-processes 1, 2 and 3.

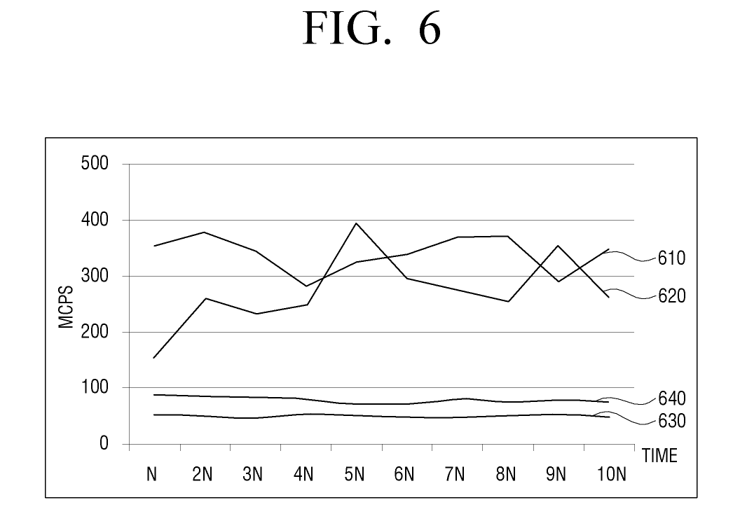

FIG. 6 illustrates the example of changes in complexity of each operation at each operation time.

Referring to FIG. 6, the complexity of a decoder 610 and an encoder 620 are high, and the complexity of the two post-processes 630 and 640 are relatively low.

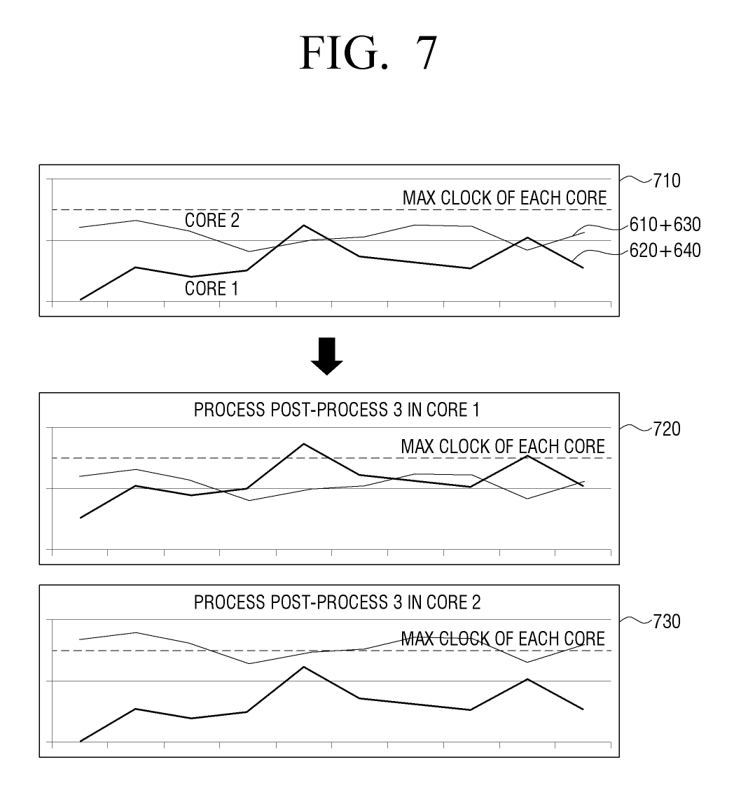

In such an environment, the example in which the distribution is performed by the conventional distribution method will be described with reference to FIG. 7.

As the complexity of the decoder 610 and the encoder 620 are high, one of the decoder and the encoder is always operated in each of the two digital signal processor cores, and each core may additionally perform the two post-processes 630 and 640 within an acceptable range.

Hence, the digital signal processor (core 1) may perform the encoder 620 and the post-process 640, and the digital signal processor (core 2) may perform the decoder 610 and the post-process 630.

If a third post-process operation is added, and added to the digital signal processor (core 1), the maximum clock of core 1 may be exceeded as in 720.

Further, also in the case where the third post-process operation is added to the digital signal processor (core 2), the maximum clock of core 2 may be exceeded as in 730.

Consequently, the performance of processing of each core should be increased to distribute an operation by the conventional method.

Hereinafter, the example of operation in applying a distribution method according to an example embodiment using two digital signal processors having the same performance will be described.

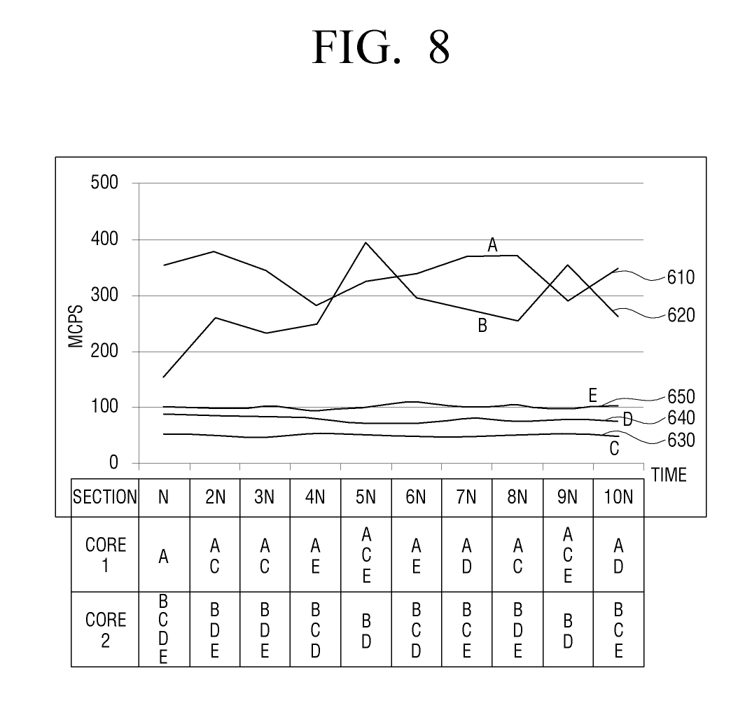

Referring to FIG. 8, an operation to be processed in each digital signal processor may be distributed based a complexity of each operation in each processing section. For example, as the complexity of the decoder 610 and the encoder 620 are high, one of the decoder and the encoder may be operated in each of the two digital signal processor cores, and the three post-process operations may be assigned to another core according to a complexity. That is, the complexity of the decoder and the encoder which are operated in each of the two digital signal processor cores may be predicted, and the three post-process operations may be divided and assigned to the two digital signal processor cores in accordance with a situation and operated, and thereby, an efficient use of a digital signal processor core may be possible.

Based on such operation, the post-processes 1 630, 2 640 and 3 650 may be distributed to two cores according to a complexity of the decoder 610 and the encoder 620 in accordance with a situation.

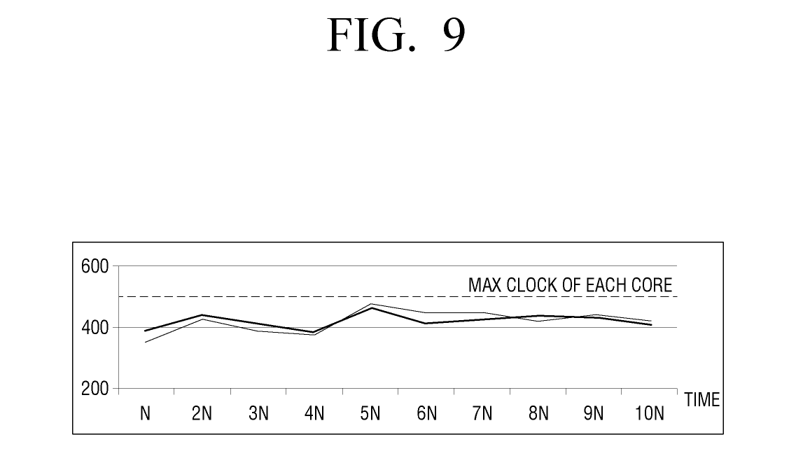

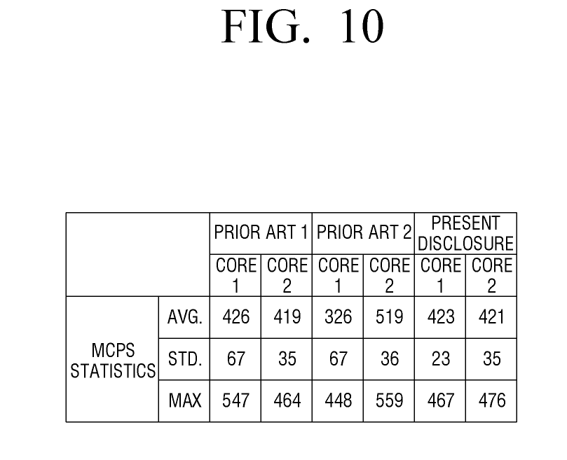

FIGS. 8 and 9 illustrate changes in complexity of each digital signal processor core according to the same distribution method. FIG. 10 illustrates complexity statistics according to the conventional method and an example embodiment.

Referring to FIGS. 9 and 10, if the distribution method according to an example embodiment is applied, the operations may be distributed and operated without exceeding the maximum operation frequency even when all five operations are operated in the two digital signal processor cores. That is, if the operations are distributed and operated simply with reference to the existing maximum complexity, the maximum operation frequency of a digital signal processor core needs to be increased to properly operate the operations without time delay because there is the section where the maximum operation frequency is exceeded regardless of how the operations are distributed. However, in the example embodiment, an efficient use of a digital signal processor core may be possible because the existing maximum complexity can be used as it is.

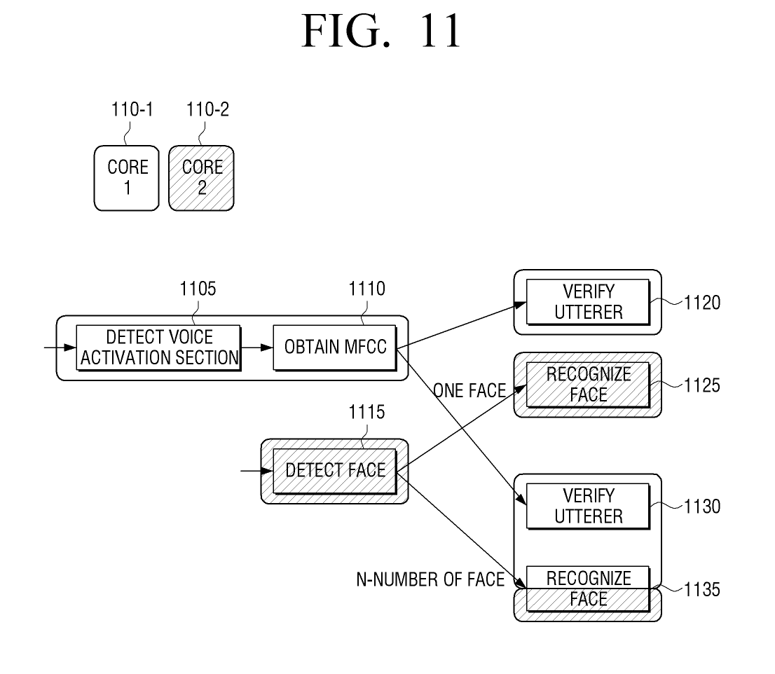

Meanwhile, only the distribution of an operation according to a predicted complexity of each operation has been described, but the distribution of an operation may be performed considering an operation situation. The related example embodiment will be described referring to FIG. 11.

FIG. 11 is a diagram illustrating an example of distributing an operation in each situation. The method for performing a user authentication which uses a voice and a face using two digital signal processor cores will be described.

Referring to FIG. 11, one core 110-2 of the two cores 110-1 and 110-2 may be specialized in face recognition.

Thus, when distributing an operation, the prediction processor 120 may preferentially distribute the operations 1115, 1125 and 1135 related to face recognition to the digital signal processor core 110-2, and distribute the other operations 1105, 1110, 1120 and 1130 to another digital signal processor core 110-1 considering a characteristic of an operation.

If much resource is required for face recognition as a plurality of faces are detected, the prediction processor 120 may distribute the operations such that a part of the face recognition operation can be performed in the digital signal processor core 110-1.

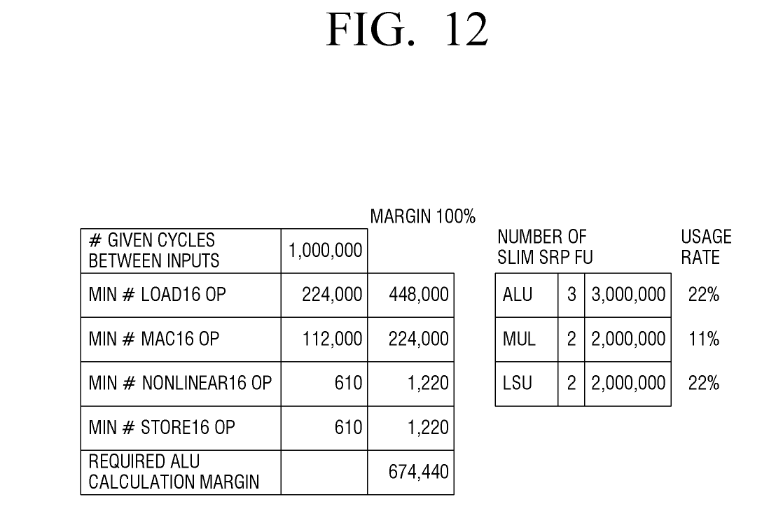

FIG. 12 is a diagram illustrating an example simulation result according to an example embodiment.

Referring to FIG. 12, the amount of computation requiring computing is 0.6 MIPOS, and the amount of computation which can provide Slim SRP is 300 MOPS. Hence, it may be possible to calculate within 0.03*N (the number of cores)ms. That is, G/C may be increased by 250G/C (to be specific, a logic, 100k, and a memory, 150k).

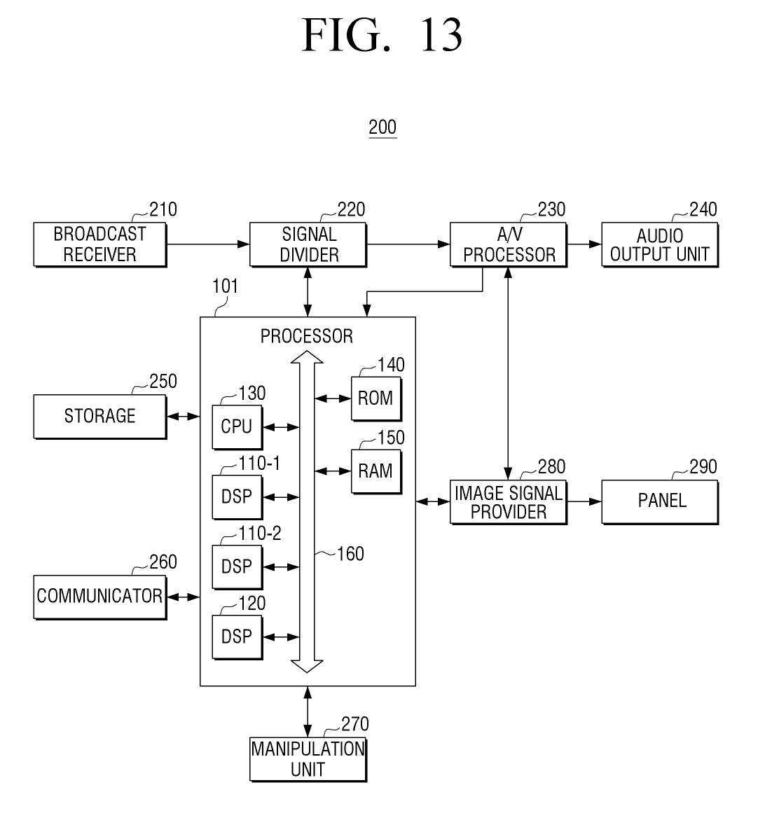

FIG. 13 is a block diagram illustrating an example configuration of an electronic apparatus including a system-on-chip according to an example embodiment.

Referring to FIG. 13, the electronic apparatus 200 according to an example embodiment may include a broadcast receiver 210, a signal divider (e.g., including signal dividing circuitry) 220, an A/V processor (e.g., including A/V processing circuitry) 230, an audio output unit (e.g., including audio output circuitry) 240, a storage 250, a communicator (e.g., including communication circuitry) 260, a manipulation unit (e.g., including input circuitry) 270, an image signal provider 280, a panel 260 and a processor (e.g., including processing circuitry) 101. The electronic apparatus 200 may be a display apparatus which displays a broadcast signal transmitted from outside. Meanwhile, although FIG. 13 illustrates the example in which the electronic apparatus is implemented as a display apparatus, some of the elements illustrated in FIG. 13 may be deleted and the electronic apparatus may be implemented by, for example, and without limitation, a set-top box, a PC, a smartphone, a note PC or the like, which are different from a display apparatus.

The broadcast receiver 210 may receive a broadcast from a broadcasting station or a satellite via cable or wirelessly and demodulate the broadcast. For example, the broadcast receiver 210 may receive a transmission stream via antenna or cable, demodulate the transmission stream, and output a digital transmission stream signal.

The signal divider 220 may include various circuitry to divide the transmission stream signal provided from the broadcast receiver 210 into an image signal, an audio signal and an additional information signal. The signal divider 220 may transmit an image signal and an audio signal to the A/V processor 230.

The A/V processor 230 may include various A/V processing circuitry and perform signal processing such as video decoding, video scaling, audio decoding, etc. with respect to the image signal and the audio signal input from the broadcast receiver 210 and the storage 250. The A/V processor 230 may output the image signal to the image signal provider 280 and the audio signal to the audio output unit 240.

If the received image and audio signals are stored in the storage 250, the A/V processor 230 may output an image and audio to the storage 250 in a compressed form.

The audio output unit 240 may include various audio output circuitry and convert the audio signal output from the A/V processor 230 into sound and output the sound through a speaker (not illustrated), or output the sound to an external device connected through an external output terminal (not illustrated).

The storage 250 may store an image content. For example, the storage 250 may be provided with an image content in which an image and audio are compressed from the A/V processor 230 and store the image content, and output the stored image content to the A/V processor 230 according to control of the processor 101. Meanwhile, the storage 250 may be implemented as a hard disk, a non-volatile memory, a volatile memory or the like.

The communicator 260 may include various communication circuitry and communicate with various types of external devices according to diverse types of communication methods. The communicator 200 may include various communication circuitry, such as, for example, and without limitation, a Wi-Fi chip and a Bluetooth chip. The processor 101 may communicate with various types of external devices using the communicator 260. Specifically, the communicator 260 may receive a control command from a control terminal device (e.g., a remote controller) which can control the electronic apparatus 200.

Also, although it is not illustrated in FIG. 2, according to an example embodiment, the communicator 260 may further include a USB port to which a USB connector can be connected, various external input ports for connecting with various external terminals such as a headset, a mouse, LAN, etc. and a Digital Multimedia Broadcasting (DMB) chip which receives and processes a DMB signal.

The manipulation unit 270 may include various input circuitry and be implemented as a touch screen, a touch pad, a key button, a key pad or the like, and provide a user manipulation of the electronic apparatus 200. In the example embodiment, the example in which a control command is received through the manipulation unit 270 provided in the electronic apparatus 200 has been described, but the manipulation unit 270 may receive a user manipulation from an external control device (e.g., a remote controller).

The image signal provider 280 may generate a graphic user interface (GUI) to be provided to a user, and add the generated GUI to an image output from the A/V processor 230. Then, the image signal provider 280 may provide an image signal corresponding to the image in which a GUI is added to the panel 290. Accordingly, the panel 290 may display various information provided by the electronic apparatus 200 and an image transmitted from the image signal provider 280.

The image signal provider 280 may obtain brightness information corresponding to the image signal, and generate a dimming signal corresponding to the obtained brightness information. The image signal provider 280 may provide the generated dimming signal to the panel 290. The dimming signal may be a PWM signal.

The panel 290 may display an image. The panel 290 may be implemented by various forms of displays such as a liquid crystal display (LCD), an organic light emitting diodes (OLED) display, a plasma display panel (PDP) or the like, but is not limited thereto. The panel 290 may include a driving circuit, a backlight unit, etc. which can be implemented by such a form as a-si TFT, low temperature poly silicon (LTPS) TFT, OTFT (organic TFT), etc. The panel 290 may also implemented as a touch screen by combining with a touch sensor.

If the panel 290 is configured with a LCD panel which displays grayscales by transmitting emitted light through an LCD or adjusting the level of transmission, the panel 290 may receive power required for a backlight through a power supply, and transmit the light emitted from the backlight to the LC. Then, the panel 290 may receive power used to a pixel electrode and a common electrode, and adjust each LC according to an image signal received in the signal provider 280, and display an image.

The backlight is configured to emit light to an LCD, and configured with a cold cathode fluorescent lamp (CCFL) and a light emitting diode (LED), etc.

The processor 101 may include various processing circuitry and control overall operations of the electronic apparatus 200. That is, the processor 101 may control the image signal provider 280 and the panel 290 to display an image according to an control command input through the manipulation unit 270.

The processor 101 may include a plurality of digital signal processors 110-1, 110-2 and 120, a CPU 130, a ROM 140, a RAM 150, a graphic processing unit (GPU, not illustrated), a bus 160, etc. The plurality of digital signal processors 110-1, 110-2 and 120, the CPU 130, the ROM 140), the RAM 150, the graphic processing unit (GPU, not illustrated) may be connected to one another through the bus. The plurality of digital signal processors may be configured in one system-on-chip as illustrated in FIG. 1. In the illustrated example, it is illustrated and described that the prediction processor is implemented as a digital signal processors, but the function of the prediction processor of FIG. 1 may be performed by the CPU 130.

The CPU 130 may access to the storage 270, and perform booting using an operating system (O/S) stored in the storage 270. The CPU 130 may also perform various operations using diverse programs, contents, data, etc. which are stored in the storage 270.

In the ROM 140, a command word set for booting a system may be stored. When a turn-on command is input and power is supplied, the CPU 130 may copy the O/S stored in the storage 250 to the RAM 150 according to a command word stored in the ROM 140, and execute the O/S and boot the system.

Once the booting is completed, the CPU 130 may copy various programs stored in the storage 250 to the RAM 150, and execute the program copied to the RAM 150 and perform various operations. Also, once the booting is completed, the GPU (not illustrated) may generate a screen including various objects such as an icon, an image, text, etc. Meanwhile, the GPU may be configured to perform the functions of the image signal provider described above, and thus, the GPU may be configured as a separate component like the image signal provider 280, or may be implemented by such a component as a SoC that is combined with a CPU provided in the processor 101.

One digital signal processor 120 of the plurality of digital signal processors may work as the prediction processor 120 as illustrated in FIG. 1. For example, the digital signal processor 120 may predict a complexity of each of a plurality of operations to be processed in the other digital signal processors 110-1 and 110-2, and distribute the plurality of operations to the plurality of digital signal processors 110-1 and 110-2 according to the predicted complexities. Meanwhile, the prediction processor 120 may be one of the digital signal processors which perform a plurality of operations, or be an exclusive digital signal processor which exclusively performs prediction and distribution. Also, such distribution may be performed in the CPU 130, not in the digital signal processor.

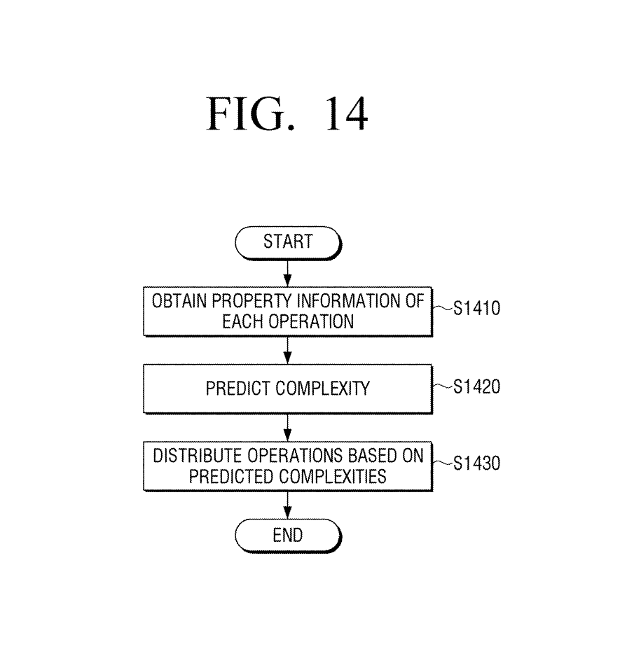

FIG. 14 is a flowchart illustrating an example data processing method according to an example embodiment.

Referring to FIG. 14, property information of a plurality of operations to be processed in a plurality of digital signal processors may be obtained (S1410). The property information of an operation may be a characteristic of computation, a parameter, etc. such as whether a TNS is used, a TNS filter degree, whether a SPX is used, a FFT point, etc. which affect a complexity of an operation.

Then, a complexity of each of the plurality of operations to be processed in the digital signal processors may be predicted (S1420). Specifically, the plurality of pieces of obtained property information may be received as input values, and a complexity of each of the plurality of operations may be predicted using a classifier which outputs one of a plurality of complexity scopes as a complexity. The classifier may use not only the plurality of pieces of obtained property information but also environment information of an electronic apparatus as input values.

The environment information may be an operation state of an electronic apparatus which may affect the performance of a digital signal processor, which may be whether certain hardware is operated, whether there is system heat, a delayed time in Dynamic Random Access Memory (DRAM) access, etc. The classifier may be a support vector machine (SVM) or a deep neural network (DNN) which learns complexities of the plurality of pieces of property information and environment information of operations. The learning may be performed online or offline, and not an electronic apparatus but a manufacturing company may perform the learning and update an internal coefficient value of a classifier through an operation of firmware update.

The plurality of operations may be distributed to the plurality of digital signal processors based on the predicted complexities (S1430). That is, the plurality of operations may be distributed to the plurality of digital signal processors based on the predicted complexities and the complexity that is processible by each of the plurality of digital signal processors. The plurality of operations may be distributed considering a priority of each of the plurality of digital signal processors. Further, the plurality of operations may be distributed additionally using a calculation result value computed in a complexity prediction process for the operations.

Once the operations are distributed, each digital signal processor may process the distributed operations.

The data processing method according to an example embodiment may predict a complexity of each operation in advance when distributing a plurality of operations to a plurality of digital signal processors, and thereby, the operations may be distributed efficiently. Accordingly, the data processing method according to an example embodiment may improve efficiency in using a plurality of digital signal processors. The data processing method as described in FIG. 14 may be executed in a system-on-chip having the components illustrated in FIG. 1 or in an electronic apparatus having the components illustrated in FIG. 13, and may also be executed in a system-on-chip or an electronic apparatus which have other different components.

The data processing method described above may be implemented by at least one program to perform the method, and the program may be stored in a non-transitory computer readable recording medium.

The non-transitory computer readable recording medium may refer to a machine-readable medium or device that stores data, and may be read by an electronic apparatus. For example, the non-transitory computer readable recording medium may be a compact disc (CD), a digital versatile disc (DVD), a hard disk, a Blu-ray disc, a universal serial bus (USB) stick, a memory card, a ROM, etc.

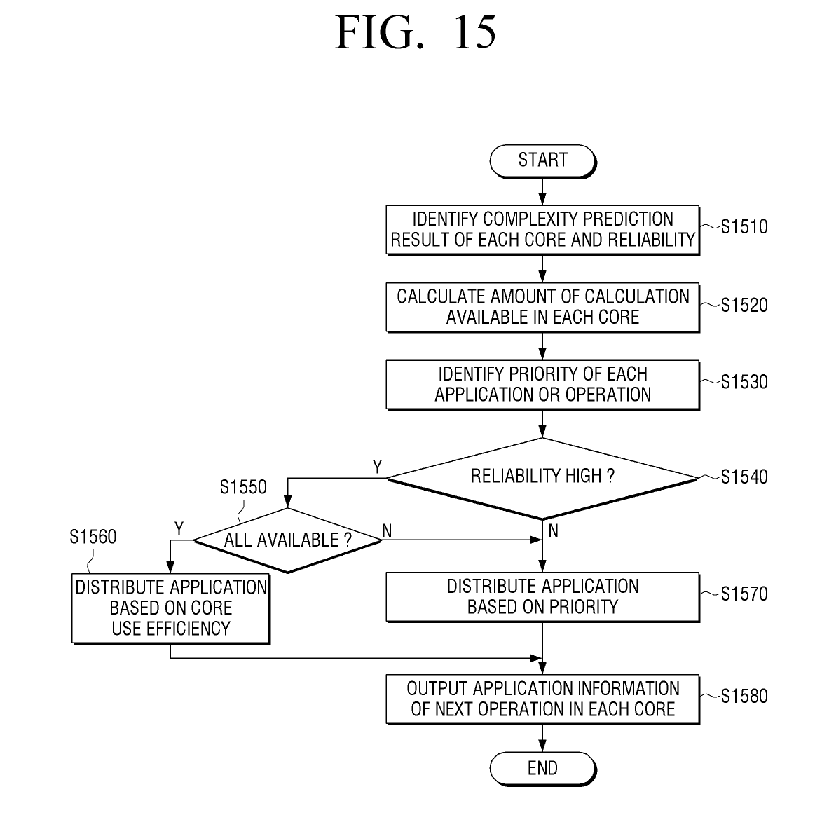

FIG. 15 is a flowchart describing an example processing method according to an example embodiment.

Referring to FIG. 15, a complexity of an operation currently processed in each digital signal processor core, a complexity of each operation to be processed in each digital signal processor core and a reliability of the calculated complexity may be calculated to identify a complexity prediction result and reliability of each core (S1510).

The amount of computation available in each digital signal processor core may be calculated or identified (S1520).

A priority of each operation (or application) may be identified (S1530).

If a reliability of the computed complexity of each operation is high (S1540—Y), it is determined whether it is possible to process all the operations (S1550).

If it is determined that it is possible to process all the operations, each operation may be distributed to a plurality of cores based on an efficiency of each core (S1560).

If it is determined that it is not possible to process all the operations (S1550—N), or if a reliability is low (S1540—N), the operation with a higher priority may be preferentially distributed among the plurality of operations to be processed (51570).

The processing operation in a next operation may be calculated by repeating the above-described operations (51580).

Consequently, the data processing method according to an example embodiment may predict a complexity of a plurality of operations before distributing the operations when distributing plurality of operations to a plurality of digital signal processors, thereby distributing an operation efficiently. Accordingly, the data processing method according to an example embodiment may improve efficiency in use of a plurality of digital signal processors. The data processing method in FIG. 15 may be executed in a system-on-chip having the components illustrated in FIG. 1 or in an electronic apparatus having the components illustrated in FIG. 13, and may also be executed in a system-on-chip or an electronic apparatus which have other components.

The data processing method described above may be implemented by at least one program to perform the method, and the program may be stored in a non-transitory computer readable recording medium.

The foregoing example embodiments and advantages are merely examples and are not to be construed as limiting the example embodiments. The description of the example embodiments is intended to be illustrative, and not to limit the scope of the disclosure, as defined by the appended claims, and many alternatives, modifications, and variations will be apparent to those skilled in the art.

What is claimed is:

1. A system-on-chip comprising:
a plurality of digital signal processors; and
a prediction processor comprising processing circuitry configured to predict a complexity of each of a plurality of operations to be processed in the plurality of digital signal processors and to distribute the plurality of operations to the plurality of digital signal processors based on the predicted complexities.

2. The system-on-chip of claim 1, wherein the prediction processor is configured to obtain a plurality of pieces of property information with respect to each of the plurality of operations, and to predict the complexity of each of the plurality of operations using a classifier comprising circuitry configured to receive the plurality of pieces of obtained property information as input values and to output one of a plurality of complexity values as a complexity.

3. The system-on-chip of claim 2, wherein the classifier is configured to receive operation environment information of the system-on-chip as an input value.

4. The system-on-chip of claim 2, wherein the classifier comprises a support vector machine (SVM) or a deep neural network (DNN) configured to learn complexities of the plurality of pieces of property information and operation environment information.

5. The system-on-chip of claim 2, wherein the classifier includes an internal coefficient value configured to be updated by update information transmitted from an external apparatus.

6. The system-on-chip of claim 2, wherein the classifier is configured to determine
a calculation result value for prediction of the complexities of the operations,
wherein the prediction processor is configured to distribute the plurality of operations in the plurality of digital signal processors using the predicted complexities and the calculation result value.

7. The system-on-chip of claim 1, wherein the prediction processor is configured to distribute the plurality of operations in the plurality of digital signal processors using a priority of each of the plurality of operations and the predicted complexities.

8. The system-on-chip of claim 7, wherein the prediction processor is configured to preferentially distribute an operation which requires a real-time process among the plurality of operations, and to distribute an operation which does not require a real-time process to a digital signal processor having sufficient resources or to delay processing of the operation.

9. The system-on-chip of claim 1, wherein the prediction processor is configured to sequentially distribute a plurality of operations to be processed in the plurality of digital signal processors using a FIFO method, and to sequentially predict complexities of the plurality of operations accumulated in the FIFO.

10. The system-on-chip of claim 1, wherein the prediction processor is configured to distribute the plurality of operations to the plurality of digital signal processors based on the predicted complexities and a complexity that is processible by each of the plurality of digital signal processors.

11. The system-on-chip of claim 1, wherein the plurality of digital signal processors and the prediction processor are disposed in one IC.

12. A method for processing data using a plurality of digital signal processors, the method comprising:
predicting a complexity of each of a plurality of operations to be processed in the plurality of digital signal processors;
distributing the plurality of operations to the plurality of digital signal processors based on the predicted complexities; and
processing the plurality of distributed operations in the plurality of digital signal processors.

13. The method of claim 12, wherein the predicting comprises obtaining a plurality of pieces of property information with respect to each of the plurality of operations, and predicting the complexity of each of the plurality of operations using a classifier configured to receive the plurality of pieces of obtained property information as input values and to output one of a plurality of complexity scopes as a complexity.

14. The method of claim 13, wherein the classifier further receives operation environment information of the system-on-chip including the plurality of digital signal processors as an input value.

15. The method of claim 13, wherein the classifier comprises a support vector machine (SVM) or a deep neural network (DNN) configured to learn complexities of the plurality of pieces of property information and operation environment information.

16. The method of claim 13, wherein the classifier includes an internal coefficient value configured to be updated by update information transmitted from an external apparatus.

17. The method of claim 13, wherein the classifier determines a calculation result value for prediction of the complexities of the operations,
wherein the distributing comprises distributing the plurality of operations in the plurality of digital signal processors using the predicted complexities and the calculation result value.

18. The method of claim 12, wherein the distributing comprises distributing the plurality of operations in the plurality of digital signal processors using a priority of each of the plurality of operations and the predicted complexities.

19. The method of claim 18, wherein the distributing comprises preferentially distributing an operation which requires a real-time process among the plurality of operations, and distributing an operation which does not require a real-time process to a digital signal processor having sufficient resources or delaying processing of the operation.

20. The method of claim 12, wherein the distributing comprises distributing the plurality of operations to the plurality of digital signal processors based on the predicted complexities and a complexity that is processible by each of the plurality of digital signal processors.
